(19) United States
(12) Patent Application Publication
(10) Pub. No.: US 2002/0112340 A1
(43) Pub. Date: Aug. 22, 2002

(54) Method for producing a hook commutator with a metal layer on one face

(76) Inventor: Klaus-Peter Haefele, Buehl (DE)

Correspondence Address: Striker Striker & Stenby, 103 East Neck Road, Huntington, NY, 11743, US

(21) Appl. No.: 09/914,086

(22) PCT Filed: Dec. 22, 2000
(86) PCT No.: PCT/DE00/04624

(30) Foreign Application Priority Data
Dec. 24, 1999 (DE) 199629722
Jul. 28, 2000 (DE) 100368190

(51) Int. Cl. H01R 43/06

(52) U.S. Cl. 29/597

(57) ABSTRACT

The invention concerns a method for producing a hook commutator for an electric motor with a metal layer (7). The metal layer (7) is applied to only one broad side (4) of a metal band (3) in a first step, so that the metal layer (7) is located on at least one interior side of the hook (20). A hook commutator is then produced in further steps. Production defects such as metal projections, metal in the commutator slit and corrosion no longer occur during production.

### RELATED ART

The invention is based on a method for producing hook commutators for electric motor armatures with a metal coating according to the general class of Claim 1.

A known method for producing a hook commutator out of copper with a tin layer comprises the following steps.

1. A copper band is stamped in accordance with a commutator geometry.

2. The copper band is bent in a circular shape.

3. The interior of the bent copper band is sprayed with plastic.

4. The copper band sprayed with plastic in this fashion is electroplated with tin or also silver-plated.

5. The commutator slits are produced by sawing, so that individual segments are produced.

6. A thermal treatment or tempering step is carried out.

7. Commutator hooks located on one end of the segments are produced by bending.

The steps listed above can be carried out in the following sequence: a) same sequence as listed above; b) 1, 2, 3, 5, 4, 6, 7; c) 1, 2, 3, 4, 6, 5, 7.

To produce the electric motor armature, a winding wire is wound around one hook each of the hook commutator, among other steps.

Hook commutators are tin-plated in order to ensure a consistently good mechanical and electric quality of the connection between commutator hook and winding wire in a process to connect, e.g., via hot-staking, the winding wire and commutator hook. The tin on an exterior side of the commutator hook, i.e., the contact surface with the electrodes of the hot-staking apparatus, has a negative effect on the hot-staking process and the service life of the electrodes.

Tin projections, if present, can lead to short circuits in an end winding.

The only way to reexpose the bare copper surfaces on the exterior side of the hook is to use an expensive brushing procedure. Moreover, this process is difficult to inspect, because a definition of “tin-free” or “bare copper” is difficult for a machine or a worker to verify.

Application of a tin coating on one side according to the processes described above can only be achieved using a laborious process of covering and/or masking the segments and commutator hooks, or by using a time-consuming process of placing the segments individually.

If tin plating (Step 4) takes place before sawing (Step 5), as listed in Sequence a), only an electroplating process can be used as the tin-plating process. In this process, the surfaces of the top and bottom side of the hook and the segments of the commutators are completely tin-plated.

The application of a tin layer cannot take place using hot-dip tinning or the process of rolling on. In the case of hot-dip tinning, the plastic inner part would be impaired. The act of rolling on a round body is more difficult than rolling on a flat metal band. Additionally, the plastic inner part could be damaged by the active forces that occur during the rolling-on process.

When using electroplating with tin to produce a tin layer on one side, the hook commutator would have to be covered in an expensive process, so that one side of the segment remains uncovered. Additionally, the covering must be completely removed after the tin-plating. Moreover, the salts contained in an electrolyte bath impair the plastic inner part and soak up water when it is stored. This leads to corrosion problems on the tin layer or the copper, and leads to problems in the further processing, e.g., with hot-staking.

If tin-plating (Step 4) takes place after sawing (Step 5) as listed in Sequence b), tin can enter the commutator slit. The only way to detect and eliminate this defect is to use a very time-consuming process of visual inspection. The application of a tin layer on one side cannot take place here using hot-dip tinning or rolling on, either. With hot-dip tinning, the plastic inner part would be impaired. The act of rolling on a round body is more difficult than rolling on a flat metal band. Additionally, the plastic inner part could be damaged by the active forces that occur during the rolling-on process. Covering the commutator during the electroplating process leads to the problems described above, and it does not prevent tin from penetrating the commutator slit.

### ADVANTAGES OF THE INVENTION

The method according to the invention having the characteristic features of Claim 1 has the advantage, in contrast, that only one coating on a side face takes place in a simple manner at the beginning of the production process for a commutator, without requiring expensive after-treatment steps.

Advantageous further developments and improvements of the method named in Claim 1 are possible using the procedure steps listed in the dependent claims.

It is advantageous when the one side is only partially coated, because this allows tin to be spared.

The use of a copper band and coating with tin is particularly advantageous, because copper is a good conductor of electricity and it is inexpensive, and tin promotes the quality of the connection well.

It is also advantageous to apply the metal layer using hot-dip tinning, because, depending on the types of metal selected for the metal band and/or layer, an intercrystalline intermediate layer is produced, which increases the quality of the connection between the metal band and the metal layer.

### DRAWING

Multiple design examples of the invention are presented in simplified form in the drawing and they are explained in greater detail in the following description.

FIGS. 1a, b show a metal band with a metal layer applied to one side or partially applied to one side.

FIGS. 2a, b show a stamped metal band according to FIGS. 1a, b.

FIGS. 3a, b, c, each show a design example for a commutator hook and a segment.

FIG. 4 shows a top view of a hook commutator, and

FIGS. 5a, b show a view along the line V-V in FIG. 4 for two design examples.

### DESCRIPTION OF THE DESIGN EXAMPLES

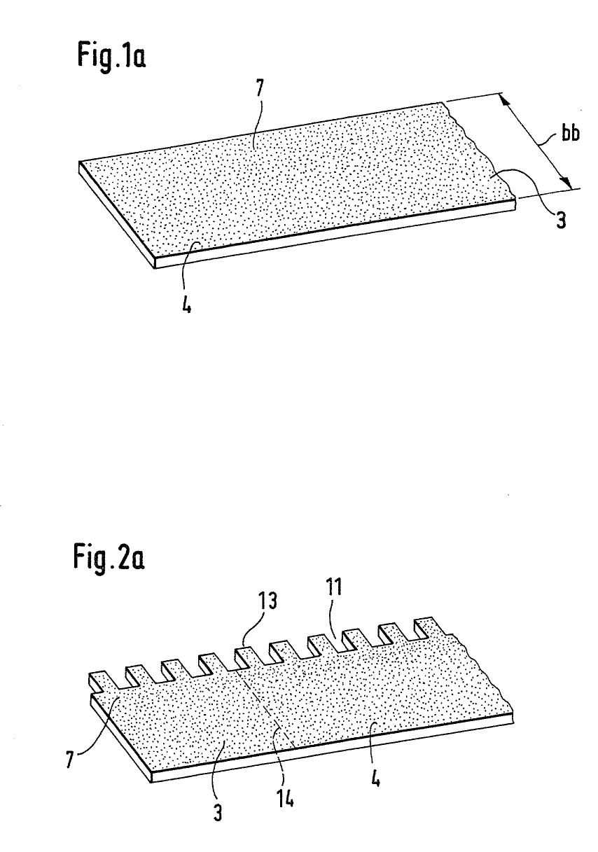

FIG. 1a shows a metal band 3 with a metal layer 7 applied on one of its broad sides 4.

FIG. 1b shows the metal band 3 with the metal layer 7, which is partially applied on one broad side 4. The metal layer 7, e.g., a connected surface, has a width br, which is smaller than the width bb of the metal band 3.

The metal band 3 is made of copper, for example. However, it can also consist of a copper alloy, for example. Since the segments 15 for the electric motor armature are later produced out of the metal band 3, good electric properties are necessary, among other things. Copper is often used because of its good electricity conducting properties.

The metal layer 7 is made of tin, for example, but it can also be made of chromium, silver or zinc, for example. The metal layer should produce a good electric and, if necessary, mechanical connection between a winding wire and commutator hook. The connection can be produced by way of soldering or a hot-staking process. If soldering is used, good wetting should take place. This is ensured with tin, zinc or silver, for example. When the hot-staking process is used, a metal with a low melting point or a metal alloy is often used, because the quality of the connection is improved when the metal or the alloy flows.

The metal layer 7 according to FIGS. 1a, b can be applied using different methods such as rolling on, hot-dip tinning, or electroplating, for example.

When the rolling-on method is used, a metal strip made of the second metal is placed on the metal band 3 made of the first metal. When rolled, the metal strip undergoes plastic deformation to a certain extent and it is connected with the metal band 3.

A width of the applied metal strip is designed so that, in the rolled-on state, it reaches the width bb (FIG. 1a) of the metal band 3, or the width br of the metal layer 7 (FIG. 1b).

In the hot-dip tinning method, the metal band 3 is immersed in a tin bath entirely (FIG. 1a) or to a certain depth that corresponds to the width br (FIG. 1b). As a result, the metal band 3 has a tin layer 7 on a front and back side. The tin layer is then removed on the surface at the appropriate sites on the metal band 3 using a simple method such as brushing. The metal band 3 can also be covered, before dipping, for example, on the entire side of one of its broad sides and, possibly, partially covered on the other broad side 4 according to FIG. 1b, so is then sprayed with plastic. An plastic inner part 25 produced in this fashion serves, for example, to slide the commutator onto a shaft.

Commutator slits 26 are produced by sawing the metal band completely through along a line 14. The line 14 runs through the recess 11 and perpendicular to the metal layer 7. An individual part produced in this fashion forms a segment 15.

As further production steps, thermal treatment or tempering is carried out as well, and the projections 13 are bent to form commutator hooks 16.

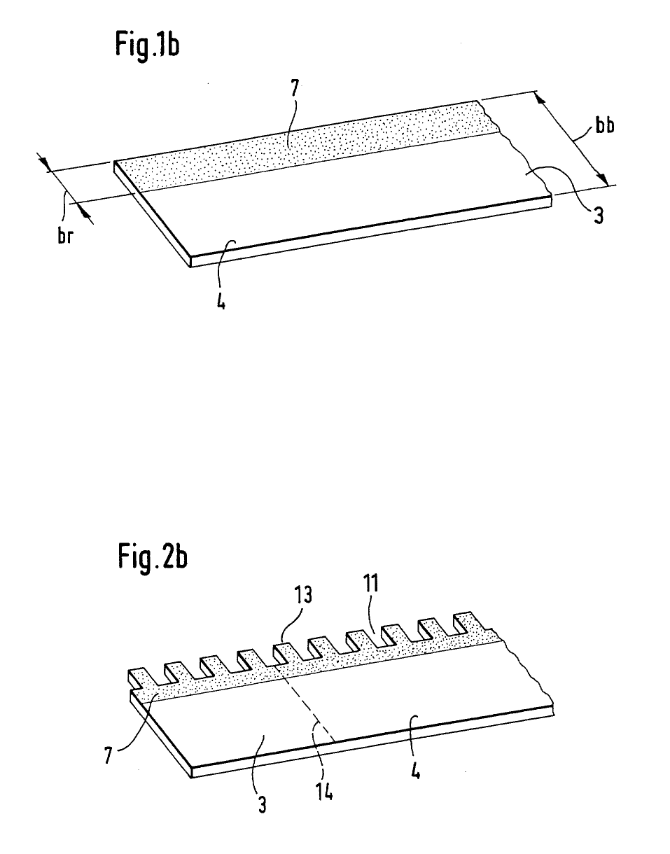

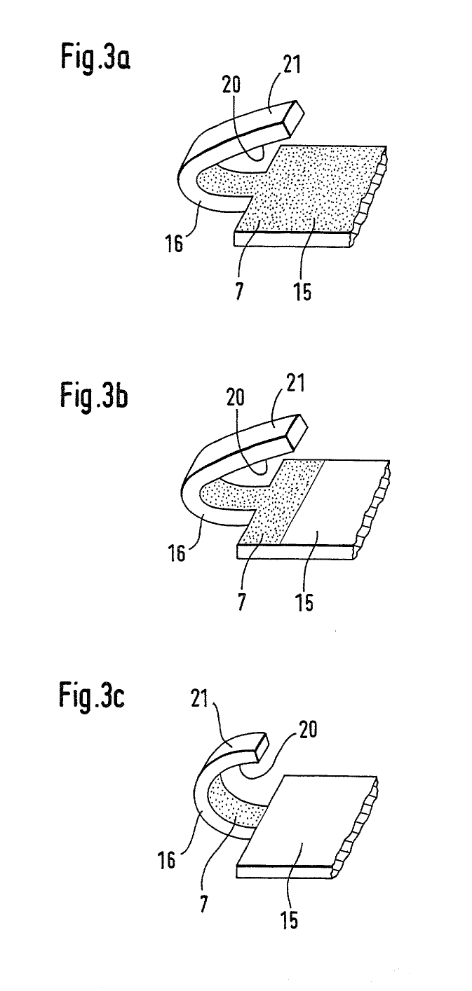

Each of the FIGS. 3a and 3b, c shows an enlarged view of a projection 13 from FIGS. 2a and 2b, whereby the projection 13 is bent in such a manner that a commutator hook 16 is produced.

In FIG. 3a, the applied metal layer 7 is located between the entire interior side of the hook 20 and on the contiguous side of the segment 15.

In FIG. 3b, the applied metal layer 7 is located between the entire interior side of the hook 20 and partially on the contiguous side of the segment 15.

FIG. 3c shows, for example, that the metal layer 7 is located only on the projection 13, which is then bent to form the commutator hook 16. The commutator hook 16 is bent in such a manner, for example, that its end does not project over the segment 15. The interior side of the hook 20 only faces itself.

A metal layer does not exist on any of the exterior sides of the hook 21 in FIGS. 3a, b, c.

The bending of the projection 13 to form the commutator hook 16 can take place in each procedure step after the metal band 7 is stamped in accordance with the commutator geometry. that the tin-plating occurs only on the other broad side 4, on the entire side or partially.

In hot-dip band tinning, a special form of hot-dip tinning, the metal band 3 is drawn over the tin bath of liquid tin in such a way that only one side of the metal band 3 comes in contact with the tin bath either entirely or partially, so that a tin layer 7 is produced on one side or partially on one side.

When hot-dip tinning is used, an intercrystalline connection is possibly produced between copper and tin. This also applies when other types of metal are used for the metal band 3 and/or the metal layer 7. Layer thicknesses of many micrometers are achieved in this fashion. Thicker metal layers 7 are possible but not necessary, however.

In the electroplating process, the metal band 3 is provided with a covering on the back side or the front side as well in such a fashion that only that part of the metal band 3 to which the metal layer 7 is to be applied is exposed. The partially covered metal band 3 is then electroplated. The covering is then removed. As with hot-tin plating, it is also possible to work without coverings in this case as well. The places provided with tin in undesired fashion can be removed quickly over large surfaces.

FIGS. 2a and 2b show a metal band 3 with a metal layer 7 according to FIGS. 1a and 2b, in which recesses 11 have been stamped in the area of the metal layer 7. This produces projections 13 which eventually form the commutator hooks 16. The metal layer 7 is located not only on the projection 13, for example, but also at least partially on the contiguous side of the metal band 3.

To produce a hook commutator 30 or motor armature, the metal band 3 is then bent in a circular shape, for example, in such a fashion that the metal layer 7 is located on the exterior surface area. The interior surface of the bent metal band 3

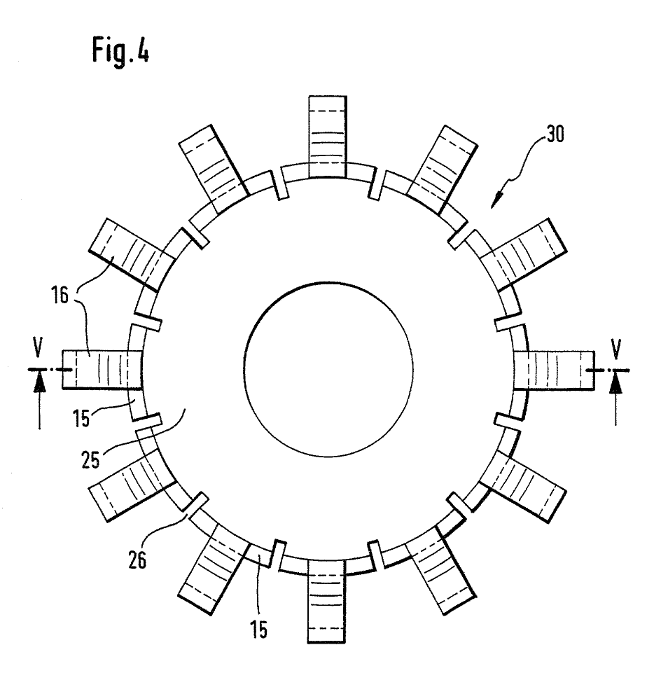

FIG. 4 shows a top view of the hook commutator 30 with twelve commutator hooks 16, for example. The plastic inner part 25 and the commutator slits 26 produced by sawing the metal band 3 are obvious. The segments 15 were produced as a result. Using the plastic inner part, the hook commutator 30 can be supported and fixed on a shaft of an electric motor.

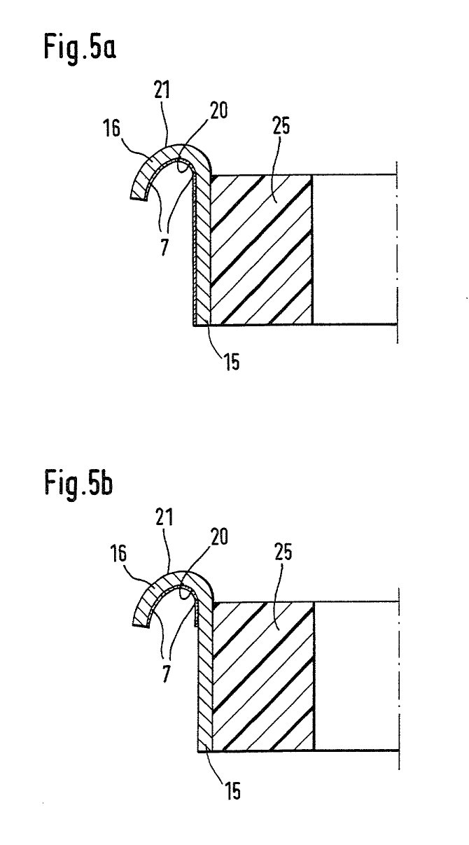

FIG. 5a shows a view along the line V-V in FIG. 4, produced from a metal band 3 according to FIG. 1a. The tin layer 7, for example, is located on just one side of the segment 15.

FIG. 5b shows a view along the line V-V in FIG. 4, produced from a metal band 3 according to FIG. 1b. The commutator hook 16 with its tin layer 7, for example, covering part of one side, was bent in such a manner that the tin layer is only located under the underside of the hook 20.

In both cases, no tin is present on the top side of the hook 21 or the side faces.

1. Method for producing hook commutators (30) for an electric motor armature, in which a metal layer (7) made of a second metal is applied to a metal band (3) made of a first metal, characterized in that the metal layer (7) of the second metal is applied to one side of the metal band (3), and the hook commutator (30) is then produced to completion.

2. Method according to claim 1, characterized in that the metal layer (7) is partially applied to one side of the metal band (3).

3. Method according to claim 1 or 2, characterized in that a band of copper or a copper alloy is used as the metal band (3).

4. Method according to claim 1 or 2, characterized in that, in producing the electric motor armature, a winding wire is wound around a commutator hook (16) of the hook commutator (30), and that the metal of the metal layer (7) increases the quality of the connection during a process to connect the commutator hook (16) and winding wire.

5. Method according to one or more of the claims 1, 2 or 4, characterized in that tin is used as the metal for the metal layer (7).

6. Method according to claim 1 or 2, characterized in that the metal layer (7) is applied to the metal band (3) by rolling on a metal strip.

7. Method according to claim 1 or 2, characterized in that the metal layer (7) is applied to the metal band (3) using hot-dip tinning.

8. Method according to claim 1 or 2, characterized in that the metal layer (7) is applied to the metal band (3) using an electroplating process.

9. Method according to one or more of the claims 1 through 3, 7 or 8, characterized in that the metal band (3) is provided with a covering so that only the part of the metal band (3) to be coated is exposed.

10. Method according to claim 9, characterized in that the metal layer (7) is applied to the metal band (3) and the covering is then removed.

11. Method according to one or more of the preceding claims, characterized in that the hook commutator (30) comprises a multitude of segments (15), on one end of which the commutator hook (16) is located, and that the metal layer (7) on the metal band (3) is so wide that, after production of the commutator hook (16), the metal layer (7) is located on only an interior side of the hook (20), or on this (20) and at least partially on the directly contiguous side of the segment.

12. Method according to one or more of the preceding claims, characterized in that the metal band (3) provided with the metal layer (7) is first stamped in accordance with a commutator geometry, then the coated metal band (3) is bent into itself in such a way that the metal layer (7) on the metal band (3) faces outward, and that two ends of the metal band (3) touch each other completely or almost touch each other, then the interior of the bent, coated metal band (3) is sprayed with plastic, and the commutator slits (26) are then sawed.

13. Method according to claim 12, characterized in that, in a procedure step to produce the hook commutator (30), the commutator hook (16) is produced via bending.

14. Method according to claim 12 or 13, characterized in that at least one thermal treatment takes place between the individual procedure steps or as the final production step.
